(19) United States
(12) Patent Application Publication
(10) Pub. No.: US 2007/0194758 A1
(43) Pub. Date: Aug. 23, 2007

(54) METHOD FOR CONSUMING ELECTRIC POWER CHARGED TO A BATTERY IN AN ELECTRONIC DEVICE WHEN THE BATTERY CANNOT BE ELECTRICALLY DECOUPLED FROM AN EXTERNAL POWER SUPPLY AND RELATED DEVICE

(76) Inventor: Ben-Chuan Du, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 11/675,085

(22) Filed: Feb. 15, 2007

(30) Foreign Application Priority Data
Feb. 22, 2006 (TW) 095105966

(51) Int. Cl. H02J 7/04

(52) U.S. Cl. 320/150

(57) ABSTRACT

When charging a battery in an electronic device, if a charging current or voltage is too high, the electronic device sends a command to stop the charging. However, if an error occurs in the charge circuit, leading to continuous charging of the battery instead of stopping the charging, then the electronic device enters a power consumption mode to consume electric power charged to the battery in the electronic device. This reduces damage due to overcharging the battery.

### BACKGROUND OF THE INVENTION

1. Field of the Invention

The present invention is related to a method for managing electric power of a battery, more particularly, to a method for consuming electric power charged to a battery in an electronic device when the battery cannot be electrically decoupled from an external power supply.

2. Description of the Prior Art

Most portable electronic devices, such as mobile phones, use a rechargeable battery as a power source. These electronic devices are capable of connecting to an adapter to charge the battery of the electronic device. For charging safety, protective circuits are installed in the electronic device to cut off a charging current to prevent the battery from exploding when a charging error occurs.

When the charging circuit of the mobile phone does not operate correctly, and therefore cannot successfully cut off the charging current, the mobile phone will send alarm signals to alert a user. However, the alarm signals are not activate indefinitely. For example, the mobile phone may cause a backlight of a display panel of the mobile phone to flash in order to alert the user. However, some mobile phones stop after the display panel has flashed several times. When the display panel flashes, the user may be too far away to notice. On the other hand, the user may check the mobile phone after the display panel has stopped flashing, such that the user continues charging the battery of the mobile phone. Under these circumstances, the battery has a high probability of exploding.

### SUMMARY OF THE INVENTION

The claimed invention provides a method for consuming electric power charged to a battery in an electronic device when the battery cannot be electrically disconnected from a power supply, the method comprising sending a command to disconnect the battery and the power supply when the power supply charges the battery to a predetermined status; detecting whether the battery is still electrically connected to the power supply after sending the command to disconnect the battery and the power supply; and entering a power consumption mode to consume electric power charged to the battery if detecting that the battery is still electrically connected to the power supply.

The claimed invention provides an electronic device comprising a battery for providing electric power to the electronic device; a first detecting device for detecting a predetermined status of a power supply charging the battery; a second detecting device for detecting whether the battery is still electrically coupled to the power supply after sending a command to decouple the battery from the power supply; a power management unit for managing electric power; and a baseband control unit coupled to the power management unit for controlling the power management unit to provide electric power to the electronic device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of a mobile phone according to the present invention.

FIG. 2 is a flow chart of controlling a charging status of the mobile phone in FIG. 1 according to the present invention.

### DETAILED DESCRIPTION

To solve the problem in the prior art that an error that occurs during battery charging may cause damage, power consuming elements are started to consume electric power that is charging a battery of a mobile phone according to the present invention.

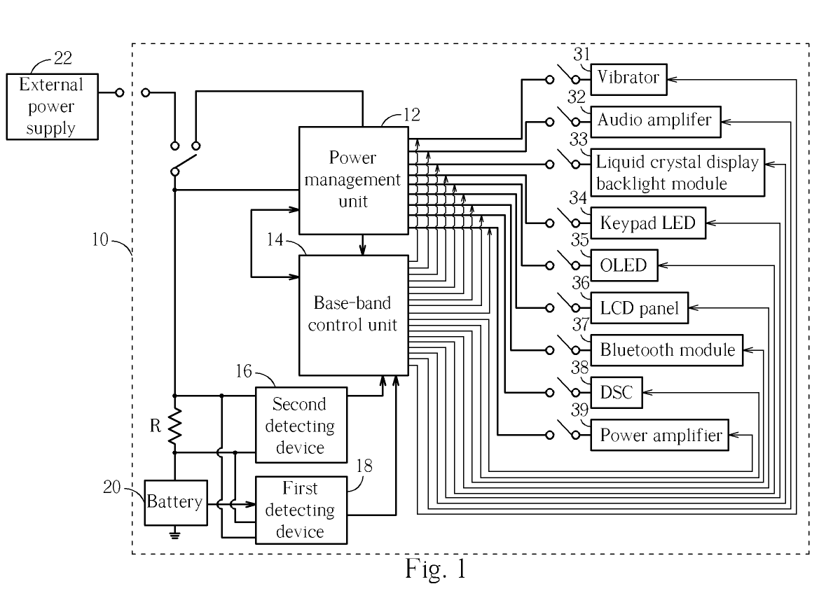

Please refer to FIG. 1. FIG. 1 is a block diagram of a mobile phone 10 according to the present invention. The mobile phone 10 includes a battery 20, a first detecting device 18, a second detecting device 16, a power management unit 12, and a baseband control unit 14. The battery 20 provides electrical power to the mobile phone 10. The power management unit 12 manages the electrical power. The baseband control unit 14 is coupled to the power management unit 12 and controls the power management unit 12 to provide the electrical power to internal elements of the mobile phone 10, such as a vibrator 31.

Potential dangers during battery charging include high charging voltage, high charging current, and high temperature of the battery, so it is necessary to detect whether a charging status of the battery is within a safe range. When the external power supply 22 charges the battery 20 of the mobile phone 10, the first detecting device 18 detects the charging status of the battery 20.

For example, a charging time of the battery 20 will be detected if it reaches a predetermined time. If the battery 20 has internal damage so that cannot be charged to full, the external power supply 22 will continue charging the battery 20. However, the battery 20 cannot store more electric energy. The excessive electric energy may damage the battery 20 or the mobile phone 10. Detecting the charging time can prevent potential danger of charging for too long.

Furthermore, the charging current and voltage can be detected by measuring a voltage across a resistor R. When the charging current and voltage are too large, i.e. outside of the safe range, danger of the battery 20 exploding increases. In general, at different charging stages, an acceptable charging current of the rechargeable battery is around 30 to 500 mA, and the external power supply 22 inputs current around 700 mA. The circuit electrically coupled between the external power supply 22 and the battery 20 can regulate the input current to be within the safe range.

The battery 20 has a thermodetector and an IC which can detect the characteristic of the battery 20, so the first detecting device 18 can determine whether the voltage of the battery 20 approaches the maximal storage or the temperature of the battery 20 approaches a predetermined temperature to prevent the battery 20 from the damage from high temperature or high voltage.

When the first detecting device 18 detects an error in the charging status, the baseband control unit 14 sends a command to decouple the battery 20 from the external power supply 22. After sending the command to decouple, the second detecting device 16 detects whether the battery 20 is still coupled to the external power supply 22. Similarly, the second detecting device 16 detects a current flowing in the resistor R by measuring the voltage of the resistor R. If the current of the resistor R is zero, or lower than the acceptable range, such as 5 mA, this means that the battery 20 and the external power supply 22 have definitely decoupled. If the second detecting device 16 detects a current larger than the acceptable range, then the external power 22 is still charging the battery 20. Because the circuit for electrically connection cannot work normally, the input current 700 mA may charge the battery 22 directly, damaging the battery 20 or causing the batter 20 to explode. Therefore, the baseband control unit 14 starts the power consumption mode to consume the large input current.

The baseband control unit 14 can start the vibrator 31 as shown in FIG. 1, which can consume approximately 100 mA of current. The baseband control unit 14 can also start other elements in the mobile phone 10. The audio amplifier, such as a speaker, a buzzer, or a headset, can consume approximately 200 mA of current. The liquid crystal display backlight module 33 can consume approximately 20 mA of current. The keypad LED 34 can consume approximately 40 mA of current. The organic light-emitting diode (OLED) 35 can consume approximately 20 mA of current. The liquid crystal display (LCD) 36 can consume approximately 40 mA of current. The bluetooth module 37 or the digital still camera (DSC) 38 can consume approximately 50 mA of current. The power amplifier 39 can consume approximately 100 to 1000 mA of current.

When the mobile phone 10 is in a power-saving mode, the baseband control unit 14 can turn off the power saving mode to consume a current of around 50 to 120 mA. Therefore, when the external or internal charging elements of the mobile phone 10 cannot work normally to cut off the charging current, the mobile phone 10 according to the present invention can start the power consuming elements to reduce the danger of the overcharging.

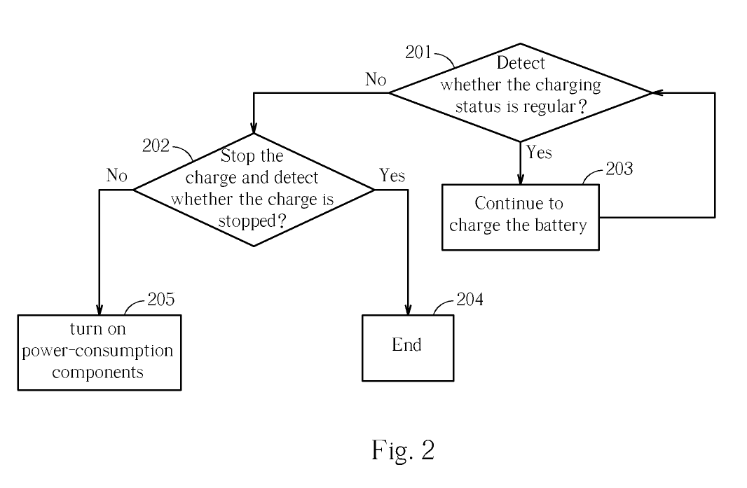

Please refer to FIG. 2. FIG. 2 is a flow chart of controlling the charging status of the mobile phone 10 in FIG. 1 according to the present invention. Steps of the method according to the present invention are as follows:

Step 201: the first detecting device 18 detects whether the charging status is regular; if yes, go to step 203; if no, go to step 202;

Step 202: the baseband control unit 14 sends a command to decouple the battery 20 from the external power supply 22; the second detecting device 16 detects whether the battery 20 is decoupled from the external power supply 22; if yes, go to Step 204; if no, go to step 205;

Step 203: continue to charge the battery 20; go to step 201;

Step 204: charging ends;

Step 205: the baseband control unit 14 starts the power consumption elements of the mobile phone 10.

The method and the device according to the present invention can have applications to the mobile phone 10 and other electronic devices, such as digital still cameras, personal digital assistants, or digital video cameras. In addition, when the mobile phone 10 according to the present invention detects the battery 20 cannot be disconnected from charging normally, the mobile phone 10 will send alarm signals to notify users, e.g. beeping from the buzzer or flashing the light of the panel.

In contrast with the prior art, the present invention provides a proper handling method that can effectively reduce the probability of the battery exploding resulting in damage and danger.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for consuming electric power charging a battery in an electronic device when the battery cannot be electrically decoupled from a power supply, the method comprising:
sending a command to decouple the battery from the power supply when the power supply charges the battery to a predetermined status;
detecting whether the battery is still electrically coupled to the power supply after sending the command to decouple the battery from the power supply; and
entering a power consumption mode to consume the electric power charging the battery when detecting that the battery is still electrically coupled to the power supply.

2. The method of claim 1, wherein the predetermined status is that a voltage of the battery reaches a predetermined voltage.

3. The method of claim 1, wherein the predetermined status is that a temperature of the battery reaches a predetermined temperature.

4. The method of claim 1, wherein the predetermined status is that a charging current from the power supply reaches a predetermined current.

5. The method of claim 1, wherein the predetermined status is that a charging voltage outputted from the power supply reaches a predetermined voltage.

6. The method of claim 1, wherein the predetermined status is that a charging time of the electronic device reaches a predetermined time.

7. The method of claim 1, wherein the predetermined status is that a charging current to the battery exceeds a predetermined current.

8. The method of claim 1, wherein entering the power consumption mode comprises starting a speaker, a buzzer, a headset, a liquid crystal display backlight module, a keypad light-emitting diode, an organic light-emitting diode, a liquid crystal display panel, a Bluetooth module, a vibrator, a digital still camera, or a power amplifier.

9. The method of claim 1, wherein entering the power consumption mode comprises turning off a power-saving mode of the electronic device.

10. The method of claim 1 wherein the electronic device is a mobile phone, a digital camera, a personal digital assistant, or a digital video camera.

11. The method of claim 1 further comprising:
sending an alarm signal after sending the command to decouple the battery from the power supply.

12. An electronic device comprising:
a battery for providing electric power to the electronic device;
a first detecting device for detecting a predetermined status of a power supply charging the battery;
a second detecting device for detecting whether the battery is still electrically coupled to the power supply after sending a command to decouple the battery from the power supply;
a power management unit for managing electric power; and
a baseband control unit coupled to the power management unit for controlling the power management unit to provide electric power to the electronic device.

13. The electronic device of claim 12 being a mobile phone, a digital camera, a personal digital assistant, or a digital video camera.
